(19) United States
(12) Patent Application Publication
(10) Pub. No.: US 2010/0217618 A1
(43) Pub. Date: Aug. 26, 2010

(54) Event Detection Based on Location Observations and Status Conditions of Healthcare Resources

(76) Inventors: Charles J. Piccirillo, Apex, NC (US); Timothy D. Wildman, Metamora, IN (US); Carl William Riley, Milan, IN (US); Christopher Andrew Mathura, Cary, NC (US); Williams F. Collins, JR., Columbus, IN (US); Karl Eric Harper, Durham, NC (US); David E. Beuning, Holly Springs, NC (US); James Richard Jester, Wake Forest, NC (US); Katherine Vigneron, Blaine, MN (US)

Correspondence Address: BARNES & THORNBURG, LLP, 11 SOUTH MERIDIAN STREET, INDIANAPOLIS, IN, 46204, US

(21) Appl. No.: 12/392,161

(22) Filed: Feb. 25, 2009

(51) Int. Cl. G06Q 50/00; G06Q 10/00; G01C 21/00; G06Q 30/00; G08B 1/08; G06T 11/20

(52) U.S. Cl. 705/2; 705/7; 701/300; 705/34; 705/9; 705/8; 340/539.12; 345/440

(57) ABSTRACT

Methods, systems and apparatus for initiating actions in a healthcare environment are disclosed. Illustrative embodiments receive identification data from tags assigned to healthcare resources via local positioning sensors. The illustrative embodiments also determine proximity of the healthcare resources based upon the identification data received via local positioning sensors. The embodiments also determine that an event has occurred in response to the proximity of the healthcare resources satisfying a relational condition of the event that relates the healthcare resources, and the healthcare resources satisfying a status condition of the event. The embodiments further initiate an action associated with the event in response to determining that the event has occurred.

### BACKGROUND OF THE INVENTION

The present invention is related to monitoring activities and more particularly monitoring activities of persons and equipment in a healthcare environment.

Caregivers such as nurses and other staff in a hospital ward, hospital wing, or other healthcare facility generally work under high pressure, high stress and long hours. These caregivers should be highly responsive to patient needs, in non-emergency as well as emergency situations. Due to ever-increasing costs of healthcare and other economic practicalities, efficient deployment of the caregivers in a healthcare facility is desired, particularly at night when the number of caregivers is typically maintained at a minimum. Nevertheless, optimizing efficiency is of secondary importance relative to the primary objective of providing a high level of healthcare.

One approach to maximizing the efficiency of caregivers such as nurses in a hospital facility involves the use of a location and identification system to continuously monitor the location of the caregivers. For instance, U.S. Pat. No. 4,275,385 to White, which is incorporated herein by reference, discloses a personnel locating system where individuals to be located wear transmitters, and each transmitter transmits a signal which corresponds to the identity of the wearer. This information is relayed to and displayed at a central control unit. The information may also be displayed at remote terminals, used to control access to equipment or locations, or conveyed via a telephone interface to a telephone switching network to call the nearest telephone or to page the wearer of the transmitter. Additionally, newer communications systems provide even more than the relatively simple locating and telephoning features disclosed in White. For example, U.S. Pat. No. 5,561,412 to Novak et al., U.S. Pat. No. 5,699,038 to Ulrich et al., and U.S. Pat. No. 5,838,223 to Gallant et al., all of which are incorporated herein by reference, disclose the use of communications systems that integrate several aspects of personnel and equipment locating, call/code enunciation, and equipment status information.

As alluded to above, caregiver (e.g., nurse) to patient ratios continue to decline due to increasing economic pressures. Many healthcare facilities are exploring ways to reduce the non-value added activities of the caregivers to maintain quality care while reducing the number of caregivers per patient. Computers hold promise for aiding the caregivers to work more efficiently by eliminating activities previously performed by caregivers and/or reducing the amount of time associated with the performance of caregiver activities.

### SUMMARY OF THE INVENTION

Disclosed embodiments include systems, apparatus and/or methods that have one or more of the following features and/or steps, which alone or in any combination may comprise patentable subject matter.

According to one aspect of the disclosed embodiments, a method for initiating actions in a healthcare environment is provided. The method includes receiving first identification data from a first tag assigned to a first healthcare resource and second identification data from a second tag assigned to a second healthcare resource via local positioning sensors. The method also includes determining proximity of the first healthcare resource to the second healthcare resource based upon the first identification data and the second identification data received via local positioning sensors. The method also includes determining that an event has occurred in response to the proximity of the first healthcare resource and the second healthcare resource satisfying a relational condition of the event that relates the first healthcare resource to the second healthcare resource, and the first healthcare resource and the second healthcare resource satisfying a status condition of the event. The method further includes initiating an action associated with the event in response to determining that the event has occurred.

Pursuant to another aspect of the disclosed embodiments, methods for initiating actions in a healthcare environment further include assigning tags to different types of healthcare resources. Such methods may determine proximity of healthcare resources based upon identification data received from tags assigned to such healthcare resources. Further, such methods may detect events based upon such proximity between healthcare resources and the status of such healthcare resources. In particular, the methods may support a wide range of healthcare resources such as persons (e.g. patients, staff, doctors, nurses, transporters, housekeeping, technicians, repairmen, maintenance crews, etc.), equipment (e.g. beds, IV pumps, ventilator pumps, transports, etc.) and facilities (e.g. X-ray, operating rooms, patient rooms, recovery rooms, waiting rooms, etc.) associated with providing healthcare to patients of a healthcare facility.

Pursuant to other aspects of the disclosed embodiments, the methods may support various types of events. In particular, the methods may support billing events that bill patients for equipment used and/or services received; and/or billing events that bill the healthcare facility for equipment used and/or services received by staff of the healthcare facility. The methods also may support update events to update status information of the healthcare resources. Some methods may further request staff to verify such updates before updating the status information of a healthcare resource. The methods may also support allocation events that allocate and/or request additional healthcare resources based upon use of such healthcare resources. Contamination events may also be supported in which potentially contamination between healthcare resources is tracked, logged and/or alerted. Protocol compliance events are also contemplated by some embodiments. Protocol compliance events may result in detecting the completion of a procedure and verifying that the procedure was conducted according to a specified protocol. Methods that match healthcare resources with other healthcare resources based upon proximity and status information of the healthcare resources are also contemplated.

Pursuant to other embodiments, methods may include receiving voice commands, and determining that events have occurred based upon the voice commands. Methods may also identify communication devices proximate healthcare resources, and annunciate associated events via the identified communication devices.

Some embodiments of the methods include determining proximity of healthcare resources based upon timestamps associated with the identification data received from tags associated with the healthcare resources. Such methods may update an acyclic graph based upon the such identification data and timestamps and determine proximity of healthcare resources based upon the acyclic graph. In particular, the methods may create nodes to represent healthcare resources and edges to such nodes to represent location observations of the healthcare resources represented by the nodes

Pursuant to other embodiments of the disclosure, a management system includes sources that provide location observations for healthcare resources, and a computing device. The computing device determines relational conditions between healthcare resources based upon location observations of the plurality of sources, and detects events based upon the determined relational conditions between the healthcare resources and based upon status conditions of the healthcare resources. The computing device further initiates actions associated with the detected events. In some embodiments, the sources that provide location observations include local positioning sensors that receiving identification data from tags of the healthcare resources, and clients of the management system.

Similar to the above methods, the management systems may support a wide range of healthcare resources such as persons (e.g. patients, staff, doctors, nurses, transporters, housekeeping, technicians, repairmen, maintenance crews, etc.), equipment (e.g. beds, IV pumps, ventilator pumps, transports, etc.) and facilities (e.g. X-ray, operating rooms, patient rooms, recovery rooms, waiting rooms, etc.) associated with providing healthcare to patients of a healthcare facility. The management systems may also support various types of events. In particular, the management systems may support billing events, update events, allocation events, contamination events, protocol compliance events, and other types of healthcare related events.

Pursuant to other embodiments, management systems may receive voice commands, and determine that events have occurred based upon the voice commands. Management systems may also identify communication devices proximate healthcare resources, and annunciate associated events via the identified communication devices.

Some management systems include determining proximity of healthcare resources based upon location observations and associated timestamps for healthcare resources. Such management systems may update an acyclic graph based upon the such location observations and timestamps and may determine proximity of healthcare resources based upon the acyclic graph. In particular, the management systems may create nodes to represent healthcare resources and edges to such nodes to represent location observations of the healthcare resources represented by the nodes

Additional features, which alone or in combination with any other feature(s), such as those listed above, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures, in which:

FIG. 1 is a block diagram showing an illustrative healthcare management system that includes a workflow system, a voice recognition system, an admission discharge and transfer (ADT) system, a billing system, a local positioning system, a nurse call system, a wired communication system, and a wireless communication system;

FIG. 2 is a block diagram showing another illustrative healthcare management system in which several services provided by multiple systems of FIG. 1 are provided by a single healthcare monitoring system;

FIG. 3 is a perspective view of a patient room of a healthcare facility that shows aspects of the healthcare management systems of FIGS. 1 and 2;

FIG. 4 is a flowchart that shows a process implemented by the healthcare management systems of FIGS. 1 and 2 to permit defining rules having events and corresponding actions to perform in response to such events;

FIG. 5 is a flowchart that shows a process implemented by the healthcare management systems of FIGS. 1 and 2 to detect events specified by defined rules and initiate actions associated with detected events; and

FIG. 6 is a block diagram showing an illustrative acyclic graph that illustrates relational conditions between healthcare resources, location observations of healthcare resources, and temporal relations between healthcare resources.

### DETAILED DESCRIPTION OF THE DRAWINGS

Embodiments contemplated by this disclosure may be implemented in hardware, firmware, software, or any combination thereof. Embodiments disclosed herein may also be implemented as instructions stored on a machine-readable medium, which may be read and executed by one or more processors. A machine-readable medium may include any mechanism for storing information in a form readable by a machine (e.g., a computing device). For example, a machine-readable medium may include read only memory (ROM); random access memory (RAM); magnetic disk storage media; optical storage media; flash memory devices; and others.

The following description describes a healthcare management system 100 that performs actions based upon proximity of healthcare resources to one another and one or more status conditions associated with the proximate healthcare resources. As should be evident from the following description of illustrative healthcare management systems, healthcare resources encompass a broad range of person, places and things associated with the care of patients in a healthcare facility. The illustrative healthcare management systems attempt to manage such healthcare resources of the healthcare facility based upon one or more defined rules. In particular, the healthcare management systems in some embodiments manage one or more of the following healthcare resources based upon events and corresponding actions of defined rules: equipment (e.g. beds, transports, pumps, ventilators, etc.) used to provide healthcare to patients; workspaces (e.g. patient rooms, X-ray rooms, operating rooms, recovery rooms, inventory rooms, store rooms, maintenance facilities, etc.) in which healthcare is provided to patients; persons (e.g. doctors, nurses, housekeeping crews, transporters, administrators, technicians, repairmen, etc.) that provide healthcare and related services to patients; and patients for which healthcare is provided.

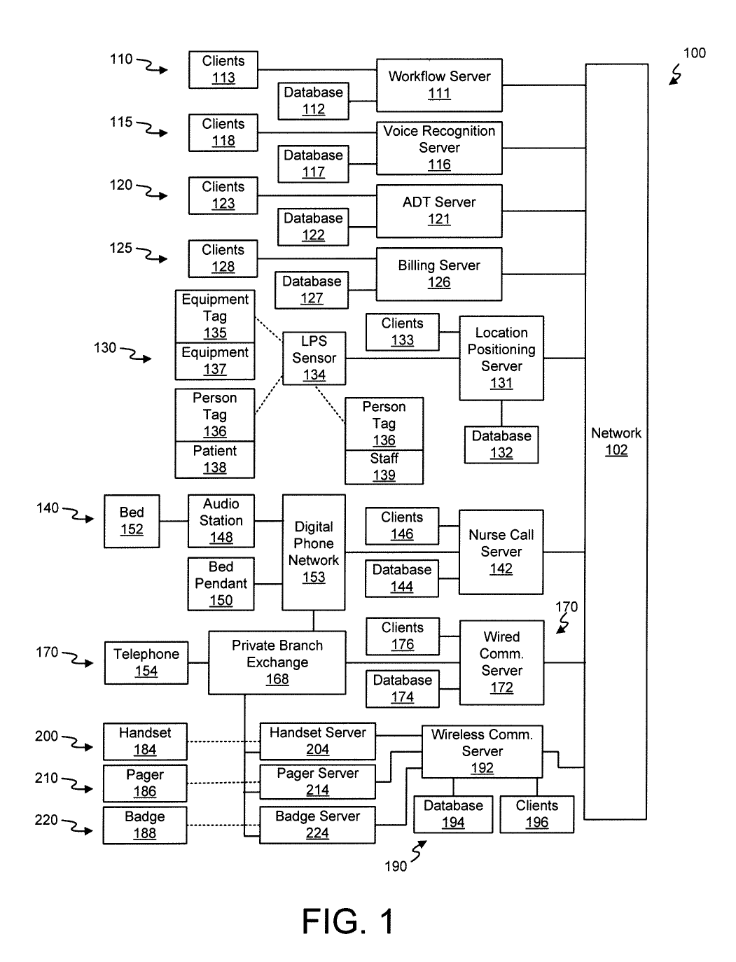

Referring now to FIG. 1, an illustrative embodiment of a management system 100 is shown. As shown, the management system 100 includes a network 102 to communicatively couple components of the management system 100 to one another. The architecture of network 102 is generally at the discretion of information technology personnel of the healthcare facility and may include additional pieces of hardware (not shown) such as switches, routers, gateways, firewalls, backup power systems, and medical equipment, such as patient monitors, hospital beds, X-ray systems, and so on having networking capability.

In the illustrative example, the management system 100 includes a workflow system 110, a voice recognition system 115, an admissions, discharge and transfer (ADT) system 120, a billing system 125, a local positioning system 130, and a nurse call system 140. The workflow system 110 includes a workflow system (WFS) server 111, a database 112, and one or more WFS clients 113. The workflow system 110 manages patient workflow through the healthcare facility. The WFS server 111 and WFS clients 113 may include desktop computers, laptop computers, handheld computers, servers and other computing devices. The WFS server 111 and WFS clients 113 may include a processor (not shown) to execute instructions of workflow software. The database 112 may be stored upon a data storage device local to the WFS server 111 and/or connected to one or more database servers of the network 102. As a result of executing the workflow software, the workflow system 110 provides the management system 100 with a workflow service. As part of the provided workflow service, the workflow server 112 may assign tasks to medical staff, track such assigned tasks, and record the completion of such assigned tasks. The workflow server 112 may also maintain patient data (e.g. electronic medical records) for patients in the database 112. Furthermore, as a result of executing workflow software, the WFS clients 113 may provide users of the workflow system 110 with an interface to the WFS server 111 and the workflow services it provides.

The voice recognition system 115, of the illustrative example, includes a voice recognition server 116, a database 117, and one or more voice recognition clients 118. The voice recognition server 116 and voice recognition clients 118 may include desktop computers, laptop computers, handheld computers, servers and other computing devices. The voice recognition server 116 and voice recognition clients 118 may include a processor (not shown) to execute instructions of voice recognition software. The database 117 may be stored upon a data storage device local to the voice recognition server 116 and/or connected to one or more database servers of the network 102. As a result of executing the recognition software, the voice recognition system 115 provides a voice recognition service to the management system 100. As part of the provided voice recognition service, the voice recognition server 116 may decipher annunciated commands received via the network 102 based upon a lexeme database and/or other data of the database 117. The voice recognition server 116 may in turn take action in response to such deciphered commands. For example, the voice recognition server 116 in one embodiment may translate the annunciated commands into a digital form understood by another system on the network and forward such digital commands to the another system. Thus, the voice recognition system 115 may be leveraged by other systems on the hospital network 102 to permit such systems to be controlled via annunciated commands. Furthermore, the voice recognition clients 118 may provide users of the voice recognition system 116 with an interface via which the voice recognition capabilities of the voice recognition server 116 may be configured and/or otherwise integrated with other systems on the network 102.

Referring now to the ADT system 120, the ADT system 120, of the illustrative example, includes an ADT server 121, a database 122, and one or more ADT clients 123. The ADT server 121 and ADT clients 123 may include desktop computers, laptop computers, handheld computers, servers and other computing devices. The ADT server 121 and ADT clients 123 may include a processor (not shown) to execute instructions of ADT software. As a result of executing the ADT software, the ADT system 120 provides the management system 100 with an ADT service. The database 122 may be stored upon a data storage device local to the ADT server 121 and/or connected to one or more database servers of the network 102. As part of the ADT service, the ADT server 121 may admit patients into the healthcare facility, discharge patients from the healthcare facility, and/or transfer patients to another healthcare facility or another area within the healthcare facility and update the database 122 accordingly. Furthermore, as a result of executing the ADT software, the ADT clients 123 may provide users of the ADT system 120 with an interface to the ADT server 121 and the ADT services that the ADT server 121 provides.

The billing system 125, of the illustrative example, includes a billing server 126, a database 127, and one or more billing clients 128. The billing server 126 and billing clients 128 may include desktop computers, laptop computers, handheld computers, servers and other computing devices. The billing server 126 and billing clients 126 may include a processor (not shown) to execute instructions of billing software. The database 127 may be stored upon a data storage device local to the billing server 126 and/or connected to one or more database servers of the network 102. As a result of executing the billing software, the billing system 125 provides the management system 100 with a billing service. As part of the billing service, the billing server 126 may update billing records of the database 127 for patients of the healthcare facility. In particular, the billing server 126 may update the billing records based upon events detected by other systems on the network 102 and/or input received from billing clients 128. Furthermore, as a result of executing the billing software, the billing clients 128 may provide users of the billing system 125 with an interface to the billing server 126 and the billing services the billing server 126 provides. Thus, such users may update billing records of the billing system 125 and generate bills for patients of the healthcare facility using the billing clients 128. The billing system 125 may further track expenses incurred by the healthcare facility as a result of equipment used and/or services received by staff of the facility.

The local positioning system 130 as shown includes an local positioning system (LPS) server 131, a database 132, LPS clients 133, LPS sensors 134, equipment tags 135, and person tags 136. The LPS server 131 and LPS clients 133 may include desktop computers, laptop computers, handheld computers, servers and other computing devices. The LPS server 131 and LPS clients 133 may include a processor (not shown) to execute instructions of LPS software. The database 132 may be stored upon a data storage device local to the LPS server 131 and/or connected to one or more database servers of the network 102. As a result of executing the LPS software, the LPS system 130 provides the management system 100 with an LPS service. As part of the LPS service, the LPS server 131 may track the location or local position of equipment 137, patients 138, staff 139 and/or other healthcare resources of the healthcare facility and update the database 132 accordingly. In particular, the LPS sensors 134 may receive signals from equipment tags 135 that have been placed, affixed, or otherwise associated with equipment 137 of the healthcare facility and may receive signals from person tags 136 that are worn by, placed upon, affixed to, or otherwise associated with patients 138, staff 139 and/or other persons in the healthcare facility.

The LPS server 131 executes LPS software to track the whereabouts of equipment 137, patients 138, staff 139 (e.g. housekeeping, nurses, doctors, caregivers, transporters, technicians, etc.) and/or other persons (e.g. visitors) throughout the associated healthcare facility. The LPS server 131 tracks such whereabouts based upon location observations received from the LPS sensors 134, clients 113, 118, 123, 128, 133, 146, 176, 196, and/or other components of the management system 100. In one embodiment, the LPS server 131 receives location observations that include timestamps that indicate the time and/or date such observations were made. The LPS server 131 may also receive location observations without an accompanying timestamp. In such cases, the LPS server 131 may time stamp such location observations based upon a time and/or date such location observations were received by the LPS server 131. In such embodiments, the LPS server 131 may determine the location of equipment 137, patients 138, staff 139 and other persons based upon such location observations and associated timestamps.

In some embodiments, the LPS sensors 134 include RF transceivers and/or IR transceivers that periodically transmit a wireless query within a limited area of the healthcare facility. The tags 135, 136 in one embodiment include active and/or passive RF transceivers and/or IR transceivers that in response to receiving the wireless query from the LPS sensors 134 transmit a response that includes identification (ID) data. The ID data in one embodiment uniquely identifies the respective tag 135, 136 and thereby uniquely identifies the healthcare resource (e.g. equipment 137, patient 138, staff 139) to which it is associated. In some embodiments, the tags 135, 136 may comprise standalone units that may be selectively attached to or otherwise associated with healthcare resources (e.g. equipment 137, patient 138, staff 139) as the need arises. The tags 135, 136 however may also be incorporated or otherwise integrated into the healthcare resources (e.g. equipment 137, bed 152) and/or another object (e.g. badges 188 discussed below) associated with a healthcare resource.

The LPS sensors 134 receive responses from tags 135, 136 within the transmitting range of the LPS sensors 134 and forward to the LPS server 131 such ID data received from the tags 135, 136 along with ID data that uniquely identifies the LPS sensor 134 that received the response from the tags 135, 136. Based upon the received ID data, the LPS server 131 identifies the tags 135 and the LPS sensors 134 and determines the location of the identified tags 135, 136 based upon the proximity of the tags 135, 136 to the identified LPS sensors 134 that received ID data from the tags 135, 136. The LPS server 131 then correlates the location of the identified tags 135, 156 to known locations of identified LPS sensor 134 in the healthcare facility. In one embodiment, the LPS sensors 134 time stamp ID data from tags 135, 136 to identify the time and/or date the ID data was received from the tags 135, 136. The LPS sensors 134 then provide the time stamped ID data to the LPS server 131 for processing. As noted above, the LPS server 131 may also receive location observations (e.g. ID data from LPS sensors 134) without timestamps. For such data, the LPS server 131 may time stamp the received observations from the LPS sensors 134 and/or may time stamp the location of a healthcare resource (e.g. equipment 137, patient 138, staff 139) determined from such received observations.

Besides location observations received from the LPS sensors 134, the LPS server 131 in one embodiment further receives location observations from clients 113, 118, 123, 128, 133, 146, 176, 196 of the management system 100 and/or other components of the management system 100. For example, staff 139 may enter location observations via such clients that indicate a patient 138 has been delivered to a patient room 300, an X-ray room, an operating room, or some other location. Staff 139 may also enter relational conditions that relate one healthcare resource (e.g. equipment 137, patient 138, staff 139, transport, workspace, etc.) to another healthcare resource. For example, staff 139 may enter into the management system 100 that a patient 138 has been assigned to a bed 152 or some other piece of equipment 137. Staff 139 may also enter into the management system 100 that a bed 152 or some other piece of equipment 137 has been assigned to the patient. In response to location observations and/or relational conditions originated from LPS sensors 134 or other sources such as clients 113, 118, 123, 128, 133, 146, 176, 196, the LPS server 131 in one embodiment further associates timestamps with such location observations and relational conditions regardless of whether the timestamp was supplied by the source (e.g. sensor 134, client 113) or the LPS server 131 itself. The LPS server 131 uses the relational conditions, timestamps, and location observations to further track the movement of healthcare resources through the facility and to determine the present and prior locations of such healthcare resources.

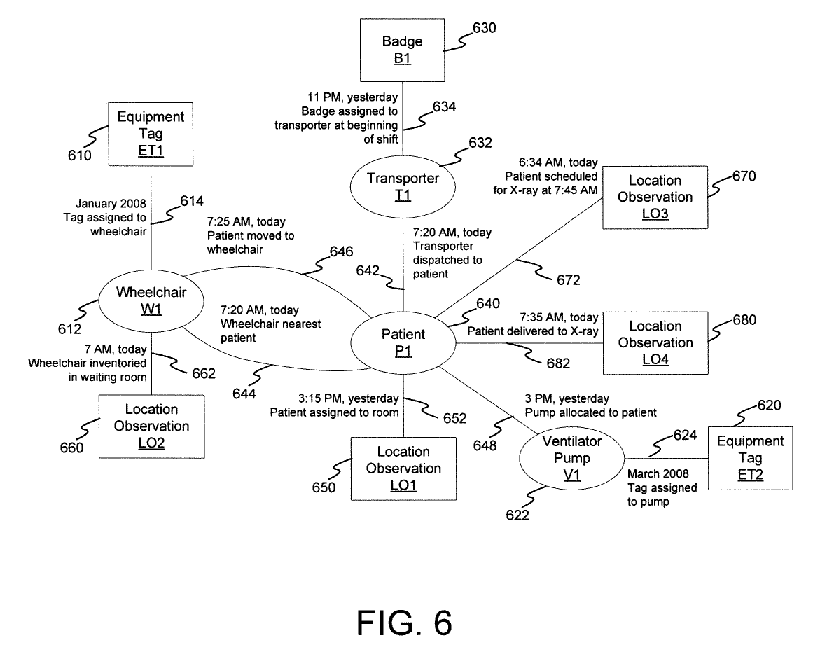

An illustrative example of time stamped location observations and relational conditions is shown in FIG. 6. As shown, the LPS server 131 may create an acyclic graph based upon such time stamped observations and relational conditions. In particular, the LPS server 131 may construct the acyclic graph using the healthcare resources (e.g. equipment 137, patients 138, staff 139 and beds 152) and observation sources (e.g. LPS sensors 134, tags 135, tags 136, and clients) as nodes or vertices of the graph and the observed relational conditions and location observations as edges between vertices of the graph. Based upon the built acyclic graph, the LPS server 131 may determine the location of a healthcare resource (e.g. equipment 137, patient 138, staff 139). In particular, the LPS server 131 may collect the relevant location observations, relational conditions, and timestamps associated with the healthcare resource by performing a tree search. The LPS server 131 may search from the node representing the healthcare resource to observation sources (e.g. LPS sensor 134, tag 135, 136, client) that have attached a location observation and/or relational condition to the healthcare resource. The LPS server 131 may then analyze the collected observations, conditions and timestamps to determine the location of the healthcare resource. In particular, LPS server 131 may rank the collected observations and conditions based on perceived timeliness and accuracy and determine the location of the healthcare resource based on such ranking.

FIG. 6 shows an illustrative acyclic graph that the LPS server 131 may construct as a result of the management system 100 scheduling and processing a patient P1 with a ventilator pump V1 for an X-ray. In particular, the LPS server 131 may construct the acyclic graph based on location observations and relational conditions associated with equipment 137 (wheelchair W1 and a ventilator pump V1), the patient 138 (patient P1), and staff 139 (transporter T1) used to schedule and process the X-ray for the patient. As shown in FIG. 6, an equipment tag ET1 has been assigned to the wheelchair W1, an equipment tag ET2 has been assigned to the ventilator pump V1 and a badge B1 has been assigned to the transporter T1. The assigned tags ET1, ET2 and badge B1 permit the LPS system 130 to respectively track the location of the wheelchair W1, ventilator pump V1, and transporter T1 via the LPS sensors 134. In one embodiment, staff 139 may enter relational conditions via one or more clients of the management system 100 to reflect the assignment of the equipment tag ET1 to the wheelchair W1, the assignment of the equipment tag ET2 to the ventilator pump V1, and the assignment of the badge B1 to the transporter T1. In response to receiving such relational conditions for the healthcare resources, the LPS server 131 updates database 132 and the acyclic graph to reflect the received relational conditions. In particular, the LPS server 131 in one embodiment creates vertices or nodes for each of the healthcare resources not already present in the acyclic graph.

For example, in response to receiving a relational condition that indicates equipment tag ET1 has been assigned to wheelchair W1, the LPS server 131 may create nodes 610, 612 to respectively represent the equipment tag ET1 and wheelchair W1 if such nodes do not already exist. Moreover, the LPS server 131 may create an edge 614 that joins the nodes 610, 612. The LPS server 131 may further define the edge 614 to reflect that the tag ET1 represented by node 610 was assigned to the wheelchair W1 represented by node 612 at the time and/or date specified by the timestamp (e.g. January 2008) of the received relational condition. Similarly, the LPS server 131 may create nodes 620, 612 for the badge B1 and transporter T1 and nodes 630, 632 for the equipment tag ET2 and ventilator pump V1. The LPS server may create edge 624 to reflect that the badge B1 was assigned to the transporter T1 at the time and/or date specified by the timestamp of the received relational condition and may create edge 634 to reflect that the equipment tag ET2 was assigned to the ventilator V1 at the time and/or date specified by the timestamp of the received relational condition.

The LPS server 131 may also receive location observations and create nodes for such location observations. For example, the LPS server 131 may receive a location observation LO1 that indicates the patient P1 was assigned to a room R. Such room assignment may result from admitting the patient P1. Accordingly, the ADT system 120 may generate and provide the location observation LO1 to the LPS server 131 as part of the patient admitting process. Besides identifying the patient P1 and the room R1, the location observation LO1 may further include a time and date (e.g. 3:15 PM, yesterday) that specifies when the patient P1 was assigned to the room R1. In response to the location observation LO1, the LPS server 131 store the received location observation LO1 and patient identity in database 132. The LPS server 131 may also create a node 640 to represent the patient P1 and a node 650 to represent the location observation LO1 if such nodes do not already exist. Furthermore, the LPS server 131 may create an edge 652 that connects the details of the location observation LO1 to the patient P1.

FIG. 6 shows additional location observations LO2, LO3, LO4 which the LPS server 131 may receive from other systems of the management system 100 and may process in a manner similar to the location observation LO1. As shown, location observation LO2 indicates that the wheelchair W1 was inventoried in the waiting room at 7 AM today. Location observation LO3 indicates that at 6:34 AM, today the patient P1 was scheduled for an X-ray to be performed at 7:45 AM today. Moreover, location observation L04 indicates that at 7:35, today the patient P1 was delivered to X-ray. In response to receiving such location observations, the LPS server 131 may store such observations in database 132 and create nodes 660, 670 and 680 to represent corresponding location observations LO2, L03 and L04. Furthermore, the LPS server 131 may create edges 662, 672 and 674 to connect the location observations LO2, LO3 and L04 to the relevant healthcare resources. In particular, the LPS server 131 may use edge 662 to connect location observation node 660 to wheelchair node 612, edge 672 to connect location observation node 670 to patient node 640, and edge 682 to connect location observation node 680 to patient node 640.

As shown, the acyclic graph may include additional edges to represent relational conditions between the healthcare resources that are received via the management system 100 or determined by the LPS server 131. In particular, the LPS server 131 may create an edge 642 between the transporter node 632 and the patient node 640 to indicate that at 7:20 AM, today that the transporter T1 was dispatched to the patient P1. The LPS server 131 may also create an edge 644 that connects the wheelchair node 612 to the patient node 640 to reflect that the wheelchair W1 was detected as being the nearest to patient P1 at 7:20 AM (i.e. the time the transporter T1 was dispatched to the patient P1). The LPS server 131 may also create an edge 646 that connects the wheelchair node 612 to the patient node 640 to reflect that the patient P1 was moved to the wheelchair W1 at 7:25 AM, today. The acyclic graph of FIG. 6 further depicts an edge 648 between the ventilator pump node 622 and the patient node 640 to reflect that the ventilator pump V1 was allocated to the patient P1 at 3 PM, yesterday.

In one embodiment, systems coupled to LPS system 130 via the network 102 such as, for example, the workflow system 110 may send a query to LPS server 131 for the location of various equipment 137 and/or persons 138, 139 in the facility. The LPS server 131 may then respond with the requested location information which the LPS server 131 deduced from the tag ID data and transceiver ID data received from the LPS sensors 134 in the facility. Alternatively or additionally, LPS server 131 may periodically update other systems coupled to the network 102 with some or all of the data corresponding to the whereabouts of the equipment 137 and persons 138, 139 being tracked by such systems.

As shown in FIG. 1, the management system 100 of the illustrative embodiment further includes a nurse call system 140 that supports communication between patients and/or caregivers of the healthcare facility. As shown, the nurse call system 140 includes a nurse call server or master station 142, a database 144 and nurse call stations or clients 146. The nurse call server 142 and nurse call clients 146 may include desktop computers, laptop computers, handheld computers, servers and other computing devices. In particular, the nurse call server 142 and nurse call clients 146 may include a processor (not shown) to execute instructions of nurse call software. The database 144 may be stored upon a data storage device local to the nurse call server 142 and/or connected to one or more database servers of the network 102. As a result of executing the nurse call software, the nurse call system 140 provides the management system 100 with a nurse call service. As part of the nurse call service, the nurse call server 142 may receive calls from a patient 138 and direct such calls to the caregiver 139 assigned to the patient based upon information stored in the database 144. Furthermore, as a result of executing the nurse call software, the nurse call clients 146 may provide users of the nurse call system 140 with an interface to the nurse call server 142 and the nurse call services it provides.

The nurse call system 140 includes audio stations 148 and bed pendants or pillow speakers 150 that are also coupled to the nurse call server 142 via a digital phone network 153. The audio stations 148 are generally mounted to walls of patient rooms and permit audio communication with caregivers stationed at the nurse call master station 142 or nurse call clients 146. Likewise, the bed pendants 150 are generally associated with beds 152 of the healthcare facility and permit audio communication with caregivers stationed at the nurse call master station 142 or nurse call clients 146. In some embodiments, the audio stations 148 and bed pendants 150 may further permit audio communication with persons stationed throughout the healthcare facility using an number of communication devices of the healthcare facility such as, for example, audio stations 148, bed pendants 150, telephones 154, wireless handsets 184, pagers 186, and wireless badges 188.

The audio stations 142 in an embodiment further provide an interface between medical equipment such as beds 152 and the network 102. In particular, beds 152 may be coupled to an audio station 142 via a wired connection. The wired connection enables a bed 152 to provide the network 102 with information regarding capabilities of the bed 152 as well as bed status information such as head angle, side rail positions, etc. The wired connection may further associate the bed 152 with the audio station 142. In one embodiment, the LPS system 130 may determine which room/area each audio station 142 is located. Thus, associating a bed 152 with an audio station 142 may inform the LPS system 130 that the respective bed 152 is in the same room/location as the audio station 142 to which it is attached. Some embodiments may further support tagging beds 152 with tags 135 or otherwise incorporating wireless tag capabilities into beds 152 so the network 102 may receive bed capabilities, bed status, location data, and/or other information regarding beds 152 via LPS sensors 134 and provide such received information to interested systems of the network 102.

As mentioned, the beds 152 may provide information regarding bed capabilities to the network 102. The beds 152 may include various capabilities that are generally beneficial to patients 130 having certain medical conditions. Such capabilities include but are not limited to full-chair patient position mechanism that places the bed 152 into a chair position at a touch of a button; a head of bed alarm that generates an alarm or alert when the head of bed is lowered below a certain angle (e.g. 30 degrees); continuous lateral rotation, percussion, and/or vibration therapies, retractable foot mechanisms which enable customizing the overall length of the bed; integrated scales which enable weighing a patient in the bed; turn assists mechanisms which aid a caregiver in turning a patient in the bed; and full-body zoned pressure-relief air surfaces to aid in preventing pressure ulcers related to immobility, to name a few. The beds 152 may inform systems of the network 102 whether they include one or more of these capabilities.

As shown, the management system 100 further includes a private branch exchange 168 that supports voice communication between telephone sets 154 of the healthcare facility. The private branch exchange 168 may be further coupled to a wired communication system 170 and to the digital phone network 153. The wired communication system 170 may include a wired communication server 172, database 174 and wired communication clients 176. The wired communication server 172 and wired communication clients 176 may include desktop computers, laptop computers, handheld computers, servers and other computing devices. In particular, the wired communication server 172 and wired communication clients 176 may include a processor (not shown) to execute instructions of wired communication software. The database 174 may be stored upon a data storage device local to the wired communication server 172 and/or connected to one or more database servers of the network 102. As a result of executing the wired communication software, the wired communication system 170 provides the management system 100 with a wired communication service. As part of the wired communication service, the wired communication server 172 may route calls received via private branch exchange 168 to other systems of the management system 100 and/or may route calls received from other systems of the management system 100 to the private branch exchange 168 and telephone sets 154 per routing information stored in the database 174. Thus, the wired communication server 172 may support voice communication between telephone sets 154 and other communication devices of the management system 100 such as, for example, nurse call master station 142, nurse call clients 146, audio station 148, bed pendent 150, handset 184, pager 186, and/or badge 188. Furthermore, as a result of executing the wired communication software, the wired communication clients 176 may provide users of the wired communication system 170 with an interface to the wired communication server 172 and the wired communication services it provides.

As shown, the management system 100 also includes a wireless communication system 190. The wireless communication system 190 may include a wireless communication server 192, database 194 and wireless communication clients 196. The wireless communication server 192 and wireless communication clients 196 may include desktop computers, laptop computers, handheld computers, servers and other computing devices. In particular, the wireless communication server 192 and wireless communication clients 196 may include a processor (not shown) to execute instructions of wireless communication software. The database 194 may be stored upon a data storage device local to the wireless communication server 192 and/or connected to one or more database servers of the network 102. As shown, the wireless communication system 190 couples a handset server 204 of a handset system 200, a pager server 214 of a pager system 210, and badge server 224 of a badge system 220 to the network 102. Thus, as a result of executing the wireless communication software, the wireless communication system 190 provides the management system 100 with a wireless communication service. As part of the wireless communication service, the wireless communication server 192 may route communication between the network 102 and handsets 184 of the handset system 200, pagers 186 of the pager system 210, badges 188 of the badge system 220.

In one embodiment, badge system 220 includes a badge server 224 and badges 188 of the type marketed by Vocera Communications, Inc. of Cupertino, Calif. and sold under the Vocera™ brand name. Such Vocera™ badges 188 may communicate over an 802.11b LAN infrastructure and also with the private branch exchange 168 via badge server 224 which executes associated Vocera™ server software. Badges 188 which communicate according to wireless communication protocols other than 802.11b, such as the Bluetooth protocol, for example, are contemplated by this disclosure. The badges 188 in one embodiment may further incorporate a person tag 136 to permit tracking of the location of the person with LPS sensors 134 of the LPS system 130.

In one embodiment, the handset system 200 provides a dedicated wireless telephone service. While it is within the scope of this disclosure for network 102 to have any type of dedicated wireless telephone service, or none at all, in one embodiment, the handset system 200 includes a dedicated wireless telephone system of the type marketed by Spectralink Corporation of Boulder, Colo. and/or ASCOM Ltd. of Beme, Switzerland. In such a system, the Spectralink™ handsets 184 communicate wirelessly via a scheme of frequency hopping spread spectrum over four TDMA channels in the 902-928 MHz radio frequency range. The Spectralink™ master control units 204 communicate with the private branch exchange 168 either via a digital and/or an analog interface.

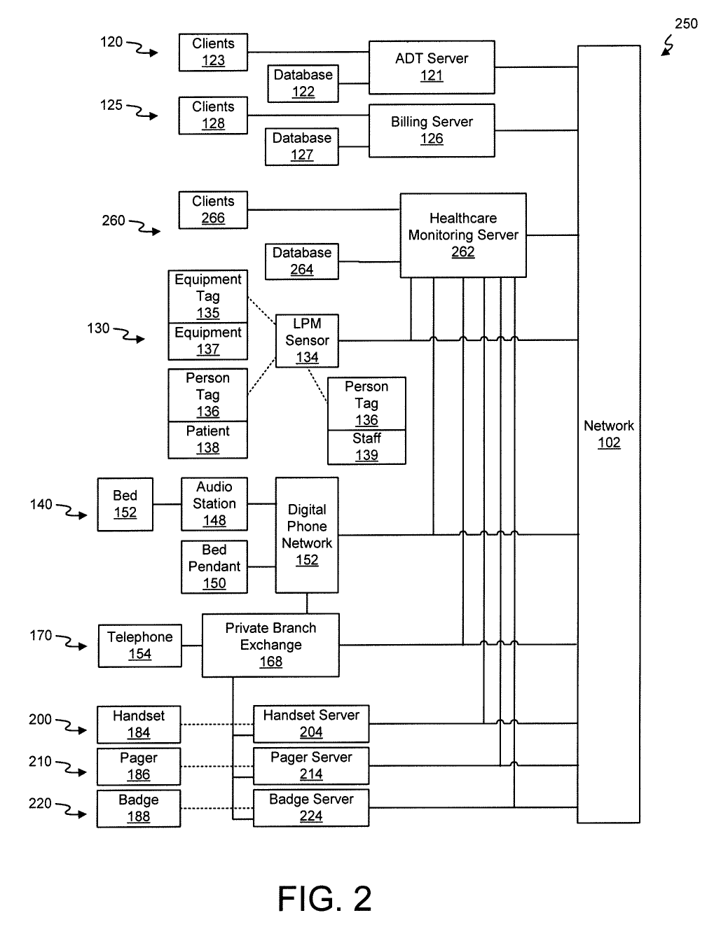

In accordance with this disclosure, the application software on servers of network 102 may be placed on other servers such that one or more of servers may be omitted from management system 100. For example, another management system 250 is shown in FIG. 2. The management system 250 is similar to the management system 100. However, in the management system 250, the workflow server 111, the voice recognition server 116, the LPS server 131, the nurse call server 142, the wired communication server 172, and the wireless communication server 192 and corresponding clients 113, 118, 133, 146, 176, 196 and databases 112, 117, 132, 144, 174, 194 have been integrated into a single healthcare monitoring system 260 having one or more healthcare monitoring servers 262, databases 264, and clients 266 which cooperate to provide the services of the workflow system 110, voice recognition system 115, location position system 130, nurse call system 140, wired communication system 170, and wireless communication system 190 of the management system 100 shown in FIG. 1. Besides potentially reducing the hardware required to implement such services, the healthcare monitoring system 260 and its clients 266 may also provide an integrated interface to the services of the management system 250. Such an integrated interface may permit users of the management system 250 to more efficiently manage patient care in the healthcare facility than the management system 100 which has such services spread across multiple systems 110, 115, 130, 140, 170, and 190.

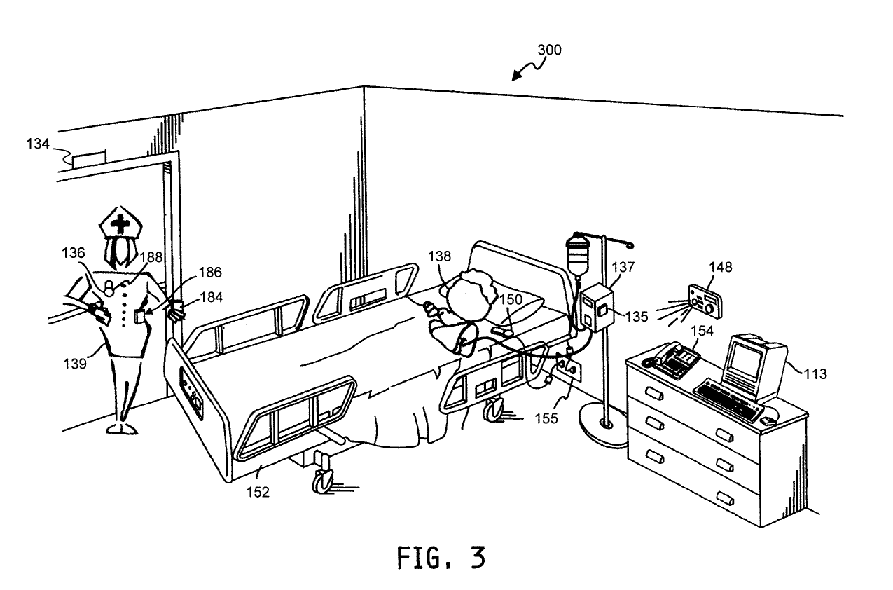

In order to provide further context regarding aspects of the management systems 100, 250, a room 300 of a healthcare facility is shown in FIG. 3. In particular, the room 300 is shown with a patient 138, healthcare personnel or provider 139 (e.g. a nurse), and a bed 152. The room 300 may be further equipped with one or more LPS sensors 134 to permit the management system 100 to track the location of patients 138, healthcare providers 139, and/or equipment 137 in the healthcare facility. The healthcare provider 139 is shown with a badge 188 and/or tag 136 which permit the management system 100 to track the location of the healthcare provider 139 in the healthcare facility. The healthcare provider 139 is further shown with a handset 184 and a pager 186. The patient 138 is shown lying in the bed 152. The bed 152 and associated bed pendant 150 are both shown connected to the digital phone network via a wall connector 155 of the room 300. While not shown, a patient badge or tag 136 may be affixed to or otherwise associated with the patient 138 to permit the management system 100 to track the location of the patient 138 in the healthcare facility. The room 300 is further shown with equipment 137 (e.g. an IV pump) associated with the patient 138. The equipment 137 is shown with an equipment tag 135 which permits the management system 100 to track the location of the equipment 137 in the healthcare facility. An audio station 148, telephone 154, and workflow client 113 are also shown in the room 300.

As noted above, the LPS services provided by the LPS system 130 and/or the healthcare monitoring system 262 permit the management systems 100, 250 to monitor or otherwise track the location of healthcare resources such as equipment 137, patients 138, staff 139, and visitors in the facility. In one embodiment, the management systems 100 may use such location tracking to trigger actions. In particular, the management systems 100, 250 may permit users to define events based upon the proximity of two or more healthcare resources to one another and conditions associated with such healthcare resources. Besides user defined events, the management systems 100, 250 may further include predefined events that are likewise based upon the proximity of two or more healthcare resources to one another. In response to such detected events, the management systems 100, 250 may invoke or otherwise initiate actions which address such detected events.

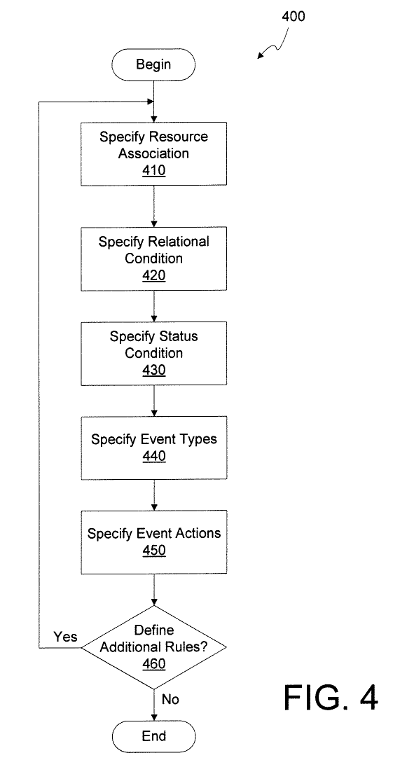

To this end, FIG. 4 show a flowchart for an illustrative method 400 which may be implemented by the management systems 100, 250. In some embodiments, the workflow server 111 or healthcare monitoring server 262 executes instructions that result in the management systems 100, 250 performing the operations of method 400. However, other servers of the management system 100, 250 may execute the instructions of method 400 in other embodiments. As a result of implementing the method 400, the management systems 100, 250 define rules that specify events and actions to be performed in response to detecting such events. The management systems 100, 250 provide interfaces via which persons such as staff 139 specify characteristics of an event and an action to perform in response to the event. In particular, the management systems 100, 250 permit persons such as staff 139 to define an event by specifying a healthcare resource association for the event at 410, a relational condition for the event at 420, a status condition for the event at 430, and a type of event at 440. At 450, the management systems 100, 250 permit persons such as staff 139 to specify an event action to be performed in response to detecting the event defined at 410, 420, 430, and 440. In one embodiment, the management systems 100, 250 permit persons such as staff 139 to specify such events and corresponding actions using one or more clients 113, 118, 123, 128, 133, 146, 176, 196 of the management systems 100, 250.

As noted above, the management systems 100, 250 at 410 permit persons such as staff 139 to specify a healthcare resource association for a rule event. In particular, the management systems 100, 250 in one embodiment support rules having healthcare resource associations between one or more pieces of equipment 137 (e.g. IV pumps, defibrillators, respirators, etc.), one or more persons (e.g. patients 138, staff 139, visitors, etc.), and/or one or more beds 152. In particular, the management systems 100, 250 may support associations between particular healthcare resources (e.g. a particular patient 138, a particular piece of equipment 137, and/or particular bed 152) and/or healthcare resource classes (e.g. a patient class, an equipment class, a bed class, etc.). Thus, persons at 410 may specify a healthcare resource association that identifies which particular healthcare resources and/or healthcare resource classes are pertinent to the rule event being defined. For example, a person may define a healthcare resource association that indicates patients 138 as a class and IV pumps 137 as a class are pertinent to the rule event. Similarly, instead of defining a healthcare resource association based upon classes of healthcare resources (e.g. a patient class and an IV pump class), the management systems 100, 250 may permit persons such as staff 139 to specify a healthcare resource association that identifies particular healthcare resources (e.g. a particular patient 138 and a particular IV pump 137).

The management systems 100, 250 further permits persons such as staff 139 to specify at 420 a relational condition to be satisfied by the healthcare resources identified by the healthcare resource association of the rule. The management systems 100, 250 may support various ways of defining a relational condition between the healthcare resources of the healthcare resource association. For example, the management systems 100, 250 may permit persons such as staff 139 to define the relational condition based upon proximity of such healthcare resources to one another. The management systems 100, 250 may also permit persons such as staff 139 to define the relation condition based upon assignment of healthcare resources to one another. In particular, the management systems 100, 250 may permit staff 139 to specify a relational condition that is satisfied based upon whether the management systems 100, 250 determine that the healthcare resources identified by the rule's healthcare resource association are co-located in the same workspace (e.g. room 300), are within a specified distance (e.g. 3 feet) of one another, are within a specified distance (e.g. 5 feet) of another healthcare resource (e.g. a LPS sensor 134), are detected by the same LPS sensor 134 or LPS sensors 134 proximate one another, some other technique for determining that the healthcare resources are proximate to one another, and/or have been assigned to one another via the WFS system 110, the ADT system 120, nurse call system 140, or some other technique for assigning resources to one another.

At 430, the management systems 100, 250 permit persons such as staff 139 to specify one or more status conditions to be satisfied by the healthcare resources identified by the healthcare resource association of the rule and a manner for determining that the event has occurred based upon the one or more status conditions. For example, the management systems 100, 250 may permit persons such as staff 139 to specify status conditions that are satisfied by a particular operating condition (e.g. ON, OFF, LOW BATTERY, IDLE, etc.) of one or more of the healthcare resources of the rule. The management systems 100, 250 may further permit persons to specify status conditions that are satisfied by particular measurements or readings (e.g. heart rate, blood oxygen level, used, complete, dirty, etc.) of one or more healthcare resources of the rules. The management systems 100, 250 may further permit persons to specify status conditions that are satisfied by certification levels, scheduling status, and contextual information associated with staff 139, patients 138 and/or equipment 137. The management systems 100, 250 further permit how such status conditions are to be processed. For example, the management systems 100, 250 permit joining the status conditions using logical operators such as AND, OR and NOT to permit detecting events and performing associated actions based upon complex logical combinations of the status conditions of the healthcare resources.

The management systems 100, 250 at 440 also permit persons to specify the type of event defined by the rule. In one embodiment, the management systems 100, 250 permit persons such as staff 139 to define various types of events such as, for example, update events, data logging events, annunciation/communication events, healthcare resource allocation/utilization events, billing events, system integration events, contamination events, communication events, checklist events, and voice events to name few. Thus, at 440, the management systems 100, 250 permit persons to specify the type of event type created at 410, 420, 430.

In one embodiment, the management systems 100, 250 permit persons such as staff 139 to add additional rules to the rules list processed by the management systems 100, 250. To this end, the management systems 100, 250 at 460 determine whether additional rules are to be defined and return to 410 if additional rules are to be defined. In particular, the management systems 100, 250 may present a query that asks whether additional rules are to be defined. In such an embodiment, the management systems 100, 250 returns to 410 in response to receiving an indication that additional rules are to be defined and exits the method 400 in response to receiving an indication that no additional rules are to be defined. In one embodiment, the management system 100, 250 may later re-invoke the method 400 to permit persons to add additional rules. The management system 100, 250 may further permit persons to edit and/or remove previously added rules from the rules list.

The operations 410, 420, 430, 440 and 450 of method 400 are described above as occurring in a sequentially, specified order. However, other embodiments of the management systems 100, 250 may permit persons to define rules in a manner that is akin to performing one or more of the operations of 410, 420, 430, 440 and 450 in a different order and/or in a concurrent or semi-concurrent fashion.

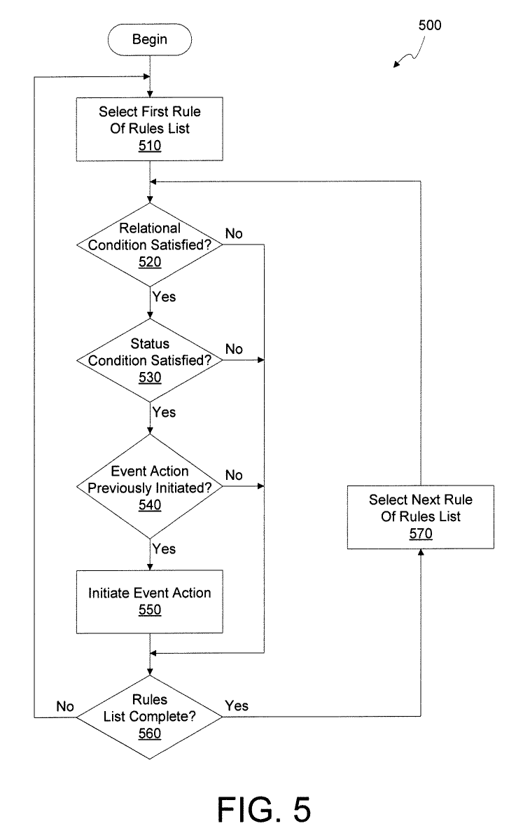

A flowchart for an illustrative method 500 implemented by the management systems 100, 250 to detect events and invoke associated actions of specified rules is shown in FIG. 5. In some embodiments, the workflow server 111 or the healthcare monitoring server 262 executes instructions that result in the management systems 100, 250 performing the operations of method 500. However, other servers of the management systems 100, 250 may execute the instructions of method 500 in other embodiments. As a result of executing such instruction, the management systems 100, 250 may create a long running process that continually determines whether an event of the rules list has occurred and initiates a corresponding action of an occurred event. As shown, the management systems 100, 250 at 510 select a first rule from the rules list for processing. At 520, the management systems 100, 250 determine whether the relational condition specified for the selected rule has been satisfied. If the relational condition of the selected rule has not been satisfied, then the management systems 100, 250 proceed to 560 to determine whether the last rule of the rules list has been processed. If the relational condition of the selected rule has been satisfied, then the management systems 100, 250 proceed to 530.

At 530, the management systems 100, 250 determine whether the status condition of the selected rule has been satisfied. If the status condition of the current rule has not been satisfied, then the management systems 100, 250 proceed to 560 to determine whether the last rule of the list has been processed. If the status condition of the current rule has been satisfied, then the management system 100, 250 proceeds to 540.

At 540, the management systems 100, 250 determine whether a previously initiated action of the selected rule is in process. If a previously initiated action of the selected rule is in process, then the management systems 100, 250 proceed to 560 to determine whether the last rule of the list has been processed. If a previously initiated action of the selected rule is not in process, then the management systems 100, 250 proceed to 550. At 550, the management systems 100, 250 initiate the action associated with the selected rule and begin processing the specified action for the rule. In one embodiment, the management systems 100, 250 mark the action as in process and clear the action once the management system 100, 250 determines that the action complete, the action has timed out, and/or the action has aborted due to some error condition. Thus, the management systems 100, 250 in one embodiment may determine at 540 whether a previously initiated action of the selected rule is in process based upon such markings.

At 560, the management systems 100, 250 determine whether the last rule of the rules list has been processed during the current rule processing cycle. In response to determining that the last rule of the rules list has been processed during the current rule processing cycle, the management systems 100, 250 return to 510 in order to start another rule processing cycle. In particular, as a result of returning to 510, the management systems 510 select the first rule of the rules list for processing. On the other hand, if the management system 100, 250 determines that the last rule of the list has not been processed during the current rule processing cycle, then the management systems 100, 250 proceed to 570. At 570, the management systems 100, 250 select the next rule of the rules list for processing and proceed to block 520 to determine whether the event of the selected rule has occurred.

To bring further clarity to operation of the management systems 100, 250, the following presents several examples of events which may be specified at 410, 420, 430, and 440 of FIG. 4 and actions that may be associated with such events at 450.

### Billing Events

As mentioned above, the management system 100, 250 support billing event rules. In general, a billing event rule specifies a healthcare resource association between two or more healthcare resources (e.g. persons 138, 139, equipment 137, beds 152, etc.), a relational condition between such healthcare resources, and at least one status condition associated with at least one of the healthcare resources of the billing event. For example, persons such as staff 139 may specify a billing event rule that bills a patient 138 for equipment usage if the management systems 100, 250 determine that the equipment 137 was used or is being used by the patient 138. In particular, a billing event rule may be specified that causes a patient 138 to be billed for the use of equipment 137 if the equipment 137 is “ON” and is proximate to or otherwise assigned to the patient 138. Thus, staff 139 may define the healthcare resource association between the patient 138 and equipment 137 at 410, the relational condition of being proximate and/or assigned to one another at 420, the status condition of the equipment 137 being “ON” at 430, and the billing event type at 440. The staff 139 may further specify a billing action 450 that results in the billing system 125 adding a billing record to reflect the patient's use of the equipment 137.

Update Events

The management systems 100, 250 also support automatic and semi-automatic update events. In general, an update event rule regardless of whether an automatic or semi-automatic update event specifies a healthcare resource association between two or more healthcare resources, a relational condition between the healthcare resources, and at least one condition associated with the specified healthcare resources of the status update event. A semi-automatic update event further specifies a query which requests staff 139 or some other person to verify the update before the management systems 100, 250 update the respective systems per the action associated with the update event. An automatic update event, on the other hand, results in the management systems 100, 250 updating the respective systems without such verification from staff 139.

For example, a semi-automatic update event rule may request staff 139 via some communications device (e.g. audio station 148, bed pendant 150, telephone 154, handset 184, pager 186, and/or badge 188) proximate and/or assigned to the staff 139 to verify whether equipment 137 in the room 300 will be used for the care of the patient 138 in response to the management systems 100, 250 detecting that the patient 138 is proximate to the equipment 137 (e.g. in the same room 300). The semi-automatic update event may further specify that the management systems 100, 250 update the status of the equipment 137 in appropriate systems (e.g. billing system 125, workflow system 110, healthcare monitoring system 260, etc.) of the management systems 100, 250 to indicate the equipment 137 is being used by the patient 138 if the caregiver 139 verifies such usage.

As an example of an automatic update event, staff 139 may specify an automatic update event rule that instructs the management systems 100, 250 to update a status entry for a piece of tagged equipment 137 to indicate the equipment 137 is “out of service” in response to the management systems 100, 250 detecting that the tagged equipment 137 is switched off and has been placed in a repair location.

### Equipment Utilization Events

Staff 139 may further define events to manage, analyze and/or increase utilization of equipment. For example, staff 139 may define events that result in the management systems 100, 250 monitoring the usage of certain equipment 137 and the demand of such equipment 137. By monitoring the usage and demand of such equipment, the management systems 100, 250 may determine that, for example, more units of such equipment are need for increased workflow or may determine more technicians to operate such equipment are needed for increased workflow and may alert staff 139 of such determinations.

Staff 139 may further define events that direct usage of specific pieces of equipment 137 to certain patients 138 based upon relational conditions and/or status conditions of such equipment 137 and/or patients 138. By directing healthcare resources (e.g. equipment 137, bed 152, etc.) to patients 138, the management systems 100, 250 may increase utilization of such equipment 137. Staff 139 may further define events that may schedule pieces of equipment 137 for maintenance or direct such equipment to technicians for such scheduled maintenance.

### Infection Control Events

The management systems 100, 250 may include rules that identify contaminated patients 138 and identify other persons (e.g. patients 138, staff 139) and equipment 137 that are likely contaminated due to the detected proximity of the contaminated patient 138 to such other persons and equipment. As such, the management systems 100, 250 may generate alerts and take other measures to control the spread of contamination.

### Protocol Compliance Events

The management systems 100, 250 may further be equipped with rules that verify protocol compliance. For example, the management systems 100, 250 may include rules that verify a nurse 139 was located in a post-op per physician's orders upon detecting a sudden cardiac death (SCD) in the post-op. Further, the management systems 100, 250 may include rules that verify whether a cooperative lifting protocol was followed by staff 139 matched with a patient 138 in need of lifting. Also, the management systems 100, 250 may include rules to verify that if a patient 138 on an IV is being moved, then the IV pump 137 matched with the patient 138 is also being moved.

### Driven Match Events

Based on status information and location, the management systems 100, 250 may create best-fit matches between persons (e.g. patients 138, staff 139), beds 152, and/or equipment 137. For example, the management systems 100, 250 may include rules that match a nurse 139 with a patient 137 based upon status and location of nurses 139 in the area of the patient 137 when the patient 137 requests a nurse 139. The management systems 100, 250 may further includes rules that locate an appropriate caregiver 139 based on skill set (e.g. housekeeping staff), availability and/or location to address a spill when staff 139 reports a spill at particular location. The management systems 100, 250 may also include rules to locate an appropriate staff member 139 based on the skill set (e.g. languages spoken), availability and/or location in response to a request from staff 139 in need of a translator. Based on received biological information (e.g., heart rate), the management systems 100, 250 per rules of the rules list may sound an alarm (e.g. a code blue alert) and may direct appropriate staff 139 (e.g. skill set, availability, and location) and appropriate equipment 137 (e.g. status and location) to the location from which the biological information was received.

### Voice Control and Annunciation Events

Based upon specified rules, the management systems 100, 250 may take appropriate actions in response to voice commands from staff 139 without the staff 139 needed to specify certain details regarding the action and/or the type of action. For example, staff 139 may state “bed is dirty” via a voice communications device (e.g. audio station 148, telephone 154, handset 184, badge 188). The management systems 100, 250 may include rules which identify the dirty bed 152 based upon the detected proximity of the caregiver 139 to a bed 152. If two or more beds 152 are detected proximate the caregiver 139, the management systems 100, 250 may request the caregiver 139 to specify which of the identified beds 152 the caregiver 139 is reporting is dirty. The management systems 100, 250 based upon the rules of the rules list may locate an appropriate staff member 139 (e.g. based upon skill set, status, and location) to notify of the dirty bed 152. The event action of the rule may result in the management systems 100, 250 automatically including an identification of the bed 152 in the notification sent to the located staff member 139.

Similarly, a caregiver 139 may state “enable bed-exit detection” via a voice communications device. The management systems 100, 250 based upon specified rules may determine whether the caregiver 139 is authorized to enable the bed-exit detection. Moreover, the management systems 100, 250 based on the caregiver's detected proximity to a bed 152, the management systems 100, 250 may identify the bed 152 for which the caregiver 139 is requesting bed-exit detection be enabled. The rules may further configure the management systems 100, 250 to remind the caregiver 139 to enable the detection system in response to certain detected conditions. For example, a rule may specify that if the caregiver 139 leaves a room 300 and status information for a patient 138 indicates that the patient's bed-exit detection system is to be enabled but the management systems 100, 250 detect the bed-exit detection system is not enabled, then the rules may direct the management systems 100, 250 to send a reminder notification to the caregiver 139. In another example, if the caregiver 139 is not sure whether the detection system was enabled, the caregiver 139 can request “status of exit detection system of bed” to determine whether the bed exit detection system of the bed 152 proximate to the caregiver 139 is enabled. In such a case, the management systems 100, 250 include rules that in response to such a request verify the authority of the caregiver 139 to issue such a request, determine the status of the exit-detection system for the identified bed 152, and provide the caregiver 139 with the requested information.

The management systems 100, 250 may further include rules that interactively guide a caregiver 139 through a process and automatically validate its completion via audible signals transmitted to the caregiver via a voice communications device proximate the caregiver 139. For example, the management systems 100, 250 may provide such interactive guides to a caregiver 139 via voice activated training manuals and may update a database upon detected completion of a checklist of steps. The management systems 100, 250 may also include rules that provide a voice accessible, interactive knowledge tree for patient diagnosis, equipment troubleshooting, etc. Besides providing such information via audible signals, the management systems 100, 250 may provide visual outputs to displays of the voice communications devices in order to provide voice access to schematics, training video, etc. The management systems 100, 250 may further include rules that provide caregivers 139 with instructions for completing their rounds. Such instructions may be activated in response to requests (e.g. verbal requests) from the caregivers 139, detected location of the caregivers 139 and/or status of the caregivers 139 (e.g. available, on-duty, on-break, etc.)

The management systems 100, 250 may further include rules that result in the execution of scripted queries. For example, based on the caregiver's status and location, the management systems may ask questions and take actions based on rules. The management systems 100, 250 may ask the caregiver 139 whether the patient 138 is ready for discharge. If the caregiver 139 responds “yes,” then the management systems 100, 250 may notify appropriate staff 139 to obtain a wheelchair or a robotic wheelchair may be commanded to go to a particular location. If the management systems 100, 250 determine that a transfer is necessary, the management systems 100, 250 may automatically notify personnel at the destination location.

### Additional Illustrative Rules

The following TABLE I presents some of the above illustrative rules as well as introduces additional illustrative rules that may be defined and processed by the management systems 100, 250. In particular, TABLE I identifies a healthcare resource association (i.e. which healthcare resources are relevant), a relational condition or proximity for the healthcare resources, a status condition, and an action for each rule. While the following TABLE show rules having resource associations of two and three healthcare resources, it should be appreciated that rules may be defined having resource associations having more healthcare resources.

TABLE I

| Resource 1 | Resource 2 | Resource 3 | Proximity | Condition | Action(s) |
|---|---|---|---|---|---|
| Patient | Equip. | | Both in | Equipment in | Bill patient for |
| | | | patient room | service (on) | equipment |
| Patient | Equip. | | Both in | Patient | Query whether |
| | | | procedure | scheduled for | equipment will |
| | | | room | a procedure | be used for care |
| | | | | | of patient |
| | | | | | Allocate and bill |
| | | | | | equipment |
| | | | | | accordingly |
| Patient | Patient | | Patient in | Patient | Bill patient for |
| | room | | patient room | assigned to | room |
| | | | | room | |
| Patient | Equip. | | Equipment | Equipment | Stop billing |
| | | | not in patient | was last in | patient for |
| | | | room | patient room | equipment |
| | | | | | Chang |
| | | | | | allocation status |
| | | | | | of equipment |
| Patient | Equip. | | Both in | Equipment | Change status of |
| | | | patient room | on for a | equipment to |
| | | | | length of | soiled after use |
| | | | | time | |
| Patient | Staff | | Both in room | Staff | Bill patient for |
| | | | | scheduled to | staff time and |
| | | | | perform | procedure |
| | | | | procedure on | |
| | | | | patient | |
| Patient | Procedure | | Patient in | Procedure | Log shortfall |
| | Room | | procedure | delayed for | Request |
| | | | room | availability of | increased |
| | | | | equipment or | allocation of |
| | | | | staff | delayed |
| | | | | | resource |
| Patient | Equip. | | In vicinity of | Equipment | Allocate |
| | | | each other | available and | equipment to |
| | | | | matches | patient |
| | | | | allocation | Initiate transport |
| | | | | request for | of equipment to |
| | | | | patient | patient |
| Patient 1 | Patient 2 | | In facility | Time | Both patients |
| | | | | stamped | have same |
| | | | | location | contagion |
| | | | | information | Annunciate |
| | | | | indicates | possible |
| | | | | patient 1 and | contamination |
| | | | | patient 2 in | connection |
| | | | | X-ray at | |
| | | | | same time | |
| Patient 1 | Patient 2 | Equip. | In facility | Time | Both patients |
| | | | | stamped | have same |
| | | | | location | contagion |
| | | | | information | Annunciate |
| | | | | indicates | possible |
| | | | | equipment | contamination |
| | | | | with patient 1 | connection |
| | | | | then with | |
| | | | | patient 2 | |
| Patient | Procedure | | Patient in | Procedure | Verify |
| | facility | | schedule | completed | history/data |
| | | | procedure | | logging for |
| | | | facility | | protocol |
| | | | | | compliance |
| Patient | Equip. | | Not in | Equipment is | Annunciate alert |
| | | | proximity of | for | |
| | | | one another | continuous | |
| | | | | use (e.g. IV) | |
| Staff | Patient | | Caregiver | Patient nurse | Annunciate call |
| | room | | nearest staff | call activated | to caregiver |
| | | | to room | | communication |
| | | | | | device |
| Staff | Service | | Staff near | Staff | Annunciate to |
| | location | | service | qualified for | staff request for |
| | | | location | service | service |
| Equip. | Repair | | Equipment in | Equipment | List equipment |
| | location | | repair | status off | as out of service |
| | | | location | | |
| Staff | Procedure | | Staff in | Procedure | Initiate |
| | facility | | procedure | scheduled | interactive |
| | | | facility | and staff | checklist |
| | | | | requests | |
| | | | | checklist | |
| Staff | Patient | | Staff in | Staff | Log time staff |
| | room | | patient room | previously | entered patient |
| | | | | reported not | room |
| | | | | in room | |
| Staff | Comm. | | Staff within | Staff | Initiate receipt |
| | Equip. | | voice range | authorized to | of voice |
| | | | of comm. | issue voice | commands via |
| | | | equip. | commands | comm. equip. |
| | | | | | Recognize |
| | | | | | command and |
| | | | | | initiate |
| | | | | | associated |
| | | | | | action |

While embodiments are disclosed, the description is not intended to be construed in a limiting sense. Various modifications of the described embodiments, as well as other embodiments which are apparent to persons skilled in the art, are deemed to lie within the spirit and scope of the appended claims.

What is claimed is:

1. A method for initiating actions in a healthcare environment, comprising
receiving first identification data from a first tag assigned to a first healthcare resource and second identification data from a second tag assigned to a second healthcare resource via local positioning sensors,
determining proximity of the first healthcare resource to the second healthcare resource based upon the first identification data and the second identification data received via local positioning sensors,
determining that an event has occurred in response to
the proximity of the first healthcare resource and the second healthcare resource satisfying a relational condition of the event that relates the first healthcare resource to the second healthcare resource, and
the first healthcare resource and the second healthcare resource satisfying a status condition of the event, and
initiating an action associated with the event in response to determining that the event has occurred.

2. The method of claim 1, further comprising
assigning the first tag to a person of the first healthcare resource, and
assigning the second tag to equipment of the second healthcare resource, wherein determining that the event has occurred in response to
determining, based upon the first identification data and the second identification data, that the proximity of the person to the equipment satisfies the relational condition of the event, and
determining that the person of the first healthcare resource has a status that satisfies the status condition of the event.

3. The method of claim 1, further comprising
assigning the first tag to equipment associated with a person of the first healthcare resource,
assigning the second tag to equipment of the second healthcare resource, and
determining that the event has occurred in response to
determining, based upon the first identification data and the second identification data, that the proximity of the person of the first healthcare resource to the equipment of the second healthcare resource satisfies the relational condition of the event, and
determining that the person of the first healthcare resource has a status that satisfies the status condition of the event.

4. The method of claim 1, further comprising
assigning the first tag to a person of the first healthcare resource, and
assigning the second tag to equipment of the second healthcare resource, wherein determining that the event has occurred in response to
determining, based upon the first identification data and the second identification data, that the proximity of the person to the equipment satisfies the relational condition of the event, and
determining that the equipment of the second healthcare resource has a status that satisfies the status condition of the event.

5. The method of claim 1, further comprising
assigning the first tag to equipment associated with a person of the first healthcare resource,
assigning the second tag to equipment of the second healthcare resource, and
determining that the event has occurred in response to
determining, based upon the first identification data and the second identification data, that the proximity of the person of the first healthcare resource to the equipment of the second healthcare resource satisfies the relational condition of the event, and
determining that the equipment of the second healthcare resource has a status that satisfies the status condition of the event.

6. The method of claim 1, further comprising
assigning the first tag to equipment of the first healthcare resource, and
assigning the second tag to equipment of the second healthcare resource, wherein
determining that the event has occurred in response to
determining, based upon the first identification data and the second identification data, that the proximity of the equipment of the first healthcare resource to the equipment of the second healthcare resource satisfies the relational condition of the event, and
determining that the equipment of the first healthcare resource has a status that satisfies the status condition of the event.

7. The method of claim 1, further comprising
assigning the first tag to a person of the first healthcare resource,
assigning the second tag to a bed of the second healthcare resource, and
determining that the event has occurred in response to
determining, based upon the first identification data and the second identification data, that the proximity of the person of the first healthcare resource to the bed of the second healthcare resource satisfies the relational condition of the event, and
determining that the person of the first healthcare resource has a status that satisfies the status condition of the event.

8. The method of claim 1, further comprising
assigning the first tag upon a person of the first healthcare resource,
assigning the second tag upon a bed of the second healthcare resource, and
determining that the event has occurred in response to
determining, based upon the first identification data and the second identification data, that the proximity of the person of the first healthcare resource to the bed of the second healthcare resource satisfies the relational condition of the event, and
determining that the bed of the second healthcare resource has a status that satisfies the status condition of the event.

9. The method of claim 1, further comprising
assigning the first tag to a person of the first healthcare resource,
assigning the second tag to a transport of the second healthcare resource, and
determining that the event has occurred in response to
determining, based upon the first identification data and the second identification data, that the proximity of the person of the first healthcare resource to the transport of the second healthcare resource satisfies the relational condition of the event, and
determining that the person of the first healthcare resource has a status that satisfies the status condition of the event.

10. The method of claim 1, further comprising
assigning the first tag to a person of the first healthcare resource,
assigning the second tag to a transport of the second healthcare resource, and
determining that the event has occurred in response to
determining, based upon the first identification data and the second identification data, that the proximity of the person of the first healthcare resource to the transport of the second healthcare resource satisfies the relational condition of the event, and
determining that the transport of the second healthcare resource has a status that satisfies the status condition of the event.

11. The method of claim 1, further comprising
determining that the event has occurred in response to
determining, based upon the first identification data and the second identification data, that the proximity of a person of the first healthcare resource to equipment of the second healthcare resource satisfies the relational condition of the event, and
determining that status information associated with the person of the first healthcare resource and the equipment of the second healthcare resource satisfies the status condition of the event, and
billing for use of the equipment of the second healthcare resource in response to initiating the action associated with the event.

12. The method of claim 11, wherein
the person comprises a patient, and
billing comprises billing the patient for the use of the equipment of the second healthcare resource.

13. The method of claim 11, wherein
the person comprises staff of the healthcare environment, and
billing comprises billing the healthcare environment for the use of the equipment of the second healthcare resource.

14. The method of claim 1, further comprising updating status information associated with the first healthcare resource in response to initiating the action associated with the event.

15. The method of claim 1, further comprising, in response to initiating the action associated with the event,
requesting staff to verify an update of status information associated with the first healthcare resource, and
updating the status information associated with the first healthcare resource in response to receiving verification of the update.

16. The method of claim 1, further comprising
determining that the event has occurred in response to determining, based upon the first identification data and the second identification data, that the first healthcare resource used the second healthcare resource, and
requesting additional allocation of the second healthcare resource in response to initiating the action associated with the event.

17. The method of claim 1, further comprising
determining that the event has occurred in response to determining, based upon the first identification data and the second identification data, that the first healthcare resource has potentially contaminated the second healthcare resource, and
alerting staff of the potential contamination in response to initiating the action associated with the event.

18. The method of claim 1, further comprising
determining that the event has occurred in response to determining, based upon the first identification data and the second identification data, that a procedure involving the first healthcare resource and the second healthcare resource was completed, and
verifying protocol compliance in response to initiating the action associated with the event.

19. The method of claim 1, further comprising matching the first healthcare resource with the second healthcare resource in response to initiating the action associated with the event.

20. The method of claim 1, further comprising
receiving a voice command, and
determining that the event has occurred based upon the voice command.

21. The method of claim 1, further comprising
identifying a communication device proximate the first healthcare resource, and
annunciating the event via the communication device proximate the first healthcare resource in response to initiating the action associated with the event.

22. The method of claim 1, further comprising determining the proximity of the first healthcare resource and the second healthcare resource based upon timestamps associated with the first identification data and the second identification data.

23. The method of claim 1, further comprising
updating an acyclic graph based upon the first identification data, the second identification data, a first timestamp associated with the first identification data, and a second timestamp associated with the second identification data, and
determining the proximity of the first healthcare resource and the second healthcare resource based upon the acyclic graph.

24. The method of claim 1, further comprising
receiving a first plurality of location observations for the first healthcare resource, the first plurality of location observations including the first identification data and an associated timestamp,
receiving a second plurality of location observations for the second healthcare resource, the second plurality of location observations including the second identification data and an associated timestamp,
updating an acyclic graph based upon the first plurality of location observations and the second plurality of location observations, and
determining the event has occurred based upon the acyclic graph.

25. The method of claim 24, wherein updating the acyclic graph includes
creating, from the first plurality of location observations, a first plurality of edges to a first node of the acyclic graph that represents the first healthcare resource, and
creating, from the second plurality of location observations, a second plurality of edges to a second node of the acyclic graph that represents the second healthcare resource.

26. The method of claim 25, wherein updating the acyclic graph includes associating timestamps to each edge of the first plurality of edges and the second plurality of edges to temporally identify location observations represented by the first plurality edges and the second plurality of edges.

27. A management system, comprising
a plurality of sources to provide location observations for a plurality of healthcare resources, and
at least one computing device to
determine relational conditions between the plurality of healthcare resources based upon location observations for the plurality of sources,
detect events based upon the determined relational conditions between the plurality of healthcare resources of the plurality of healthcare resources and status conditions of the plurality of healthcare resources, and initiate actions associated with detected events.

28. The management system of claim 27, wherein the plurality of sources includes local positioning sensors to detect locations of healthcare resource within range of the local positioning sensors.

29. The management system of claim 27, wherein
a healthcare resource of the plurality of healthcare resources has a tag to transmit identification data that identifies the healthcare resource, and
the local positioning sensors are positioned about a healthcare facility to receive the identification data from the tag of the healthcare resource.

30. The management system of claim 27, wherein
the plurality of healthcare resources includes persons, and
the at least one computing device is to determine whether relational conditions between persons of the plurality of healthcare resources are satisfied by location observations for the persons.

31. The management system of claim 27, wherein
the plurality of healthcare resources includes persons, and
the at least one computing device is to determine whether status conditions are satisfied by status information for the persons of the plurality of healthcare resources.

32. The management system of claim 27, wherein
the plurality of healthcare resources includes persons, and
the at least one computing device is to
determine proximity between a first person and a second person of the healthcare resources based upon associated location observations for the first person and the second person, and
determine whether a relational condition between the first person and the second person is satisfied by the determined proximity between the first person and the second person.

33. The management system of claim 27, wherein
the plurality of healthcare resources includes equipment, and
the at least one computing device is to determine whether relational conditions between equipment of the plurality of healthcare resources are satisfied by location observations for the equipment.

34. The management system of claim 27, wherein
the plurality of healthcare resources includes equipment, and
the at least one computing device is to determine whether status conditions are satisfied by status information of the equipment.

35. The management system of claim 27, wherein
the plurality of healthcare resources includes equipment, and
the at least one computing device is to
determine proximity between first equipment and second equipment of the healthcare resource based upon associated location observations for the first equipment and the second equipment, and
determine whether a relational condition between the first equipment and the second equipment is satisfied by the determined proximity between the first equipment and the second equipment.

36. The management system of claim 27, wherein
the plurality of healthcare resources includes persons and equipment, and
the at least one computing device is to determine whether relational conditions between the persons and equipment of the plurality of healthcare resources are satisfied by location observations for the persons and equipment.

37. The management system of claim 27, wherein
the plurality of healthcare resources includes persons and equipment, and
the at least one computing device is to determine whether status conditions are satisfied by status information of the persons and equipment.

38. The management system of claim 27, wherein
the plurality of healthcare resources includes persons and equipment, and
the at least one computing device is to
determine proximity of a person to equipment based upon associated location observations for the person and the equipment, and
determine whether a relational condition between the person and the equipment is satisfied by the determined proximity between the person and the equipment.

39. The management system of claim 27, wherein
the plurality of healthcare resources includes persons and facilities, and
the at least one computing device is to determine whether relational conditions between persons and facilities of the plurality of healthcare resources are satisfied by location observations for the persons.

40. The management system of claim 27, wherein
the plurality of healthcare resources includes persons and facilities, and
the at least one computing device is to determine whether status conditions are satisfied by status information of the persons and the facilities.

41. The management system of claim 27, wherein
the plurality of healthcare resources includes persons and facilities, and
the at least one computing device is to
determine proximity of a person to a facility based upon associated location observations for the person, and
determine whether a relational condition between the person and the facility is satisfied by the determined proximity between the person and the facility.

42. The management system of claim 27, wherein
the plurality of healthcare resources includes equipment and facilities, and
the at least one computing device is to determine whether relational conditions between equipment and facilities of the plurality of healthcare resources are satisfied by location observations for the equipment.

43. The management system of claim 27, wherein
the plurality of healthcare resources includes equipment and facilities, and
the at least one computing device is to determine whether status conditions are satisfied by status information of the equipment and the facilities.

44. The management system of claim 27, wherein
the plurality of healthcare resources includes equipment and facilities, and
the at least one computing device is to
determine proximity of equipment to a facility based upon associated location observations for the equipment, and
determine whether a relational condition between the equipment and the facility is satisfied by the determined proximity between the equipment and the facility.

45. The management system of claim 27, wherein
the plurality of healthcare resources includes persons, equipment and facilities, and
the at least one computing device is to determine whether relational conditions between persons, equipment and facilities of the plurality of healthcare resources are satisfied by location observations for the persons and equipment.

46. The management system of claim 27, wherein
the plurality of healthcare resources includes persons, equipment and facilities, and
the at least one computing device is to determine whether relational conditions between persons, equipment and facilities of the plurality of healthcare resources are satisfied by status information for the persons, equipment and facilities.

47. The management system of claim 27, wherein
the plurality of healthcare resources includes persons, equipment and facilities, and
the at least one computing device is to
determine proximity between persons, equipment and facilities based upon location observations for the persons and equipment, and
determine whether relational conditions between the persons, equipment and the facilities are satisfied by the determined proximity between the persons, equipment and the facilities.

48. The management system of claim 27, wherein the at least one computing device is to
detect an event based upon location observations for patients of the plurality of healthcare resources, location observations for equipment of the plurality of healthcare resources and status information for equipment of the plurality of healthcare resources, and
bill a patient for use of equipment of in response to initiating an action associated with the detect event.

49. The management system of claim 27, wherein the at least one computing device is to
detect an event based upon location observations for patients of the plurality of healthcare resource, status information for patients of the plurality of healthcare resources, and status information for facilities of the plurality of healthcare resources, and
bill a patient for use of a facility in response to initiating an action associated with the detected event.

50. The management system of claim 27, further comprising a plurality of communication devices, wherein the at least one computing device is to
detect an event based upon location observations associated with a first healthcare resource of the plurality of healthcare resources, location observations associated with a second healthcare resource of the plurality of healthcare resources, and status information of the second healthcare resource, and
in response to initiating an action in response to the detected event, request the first healthcare resource via a communication device of the plurality of communications to verify status information associated with the second healthcare resource, and update the status information associated with the second healthcare resource in response to receiving verification.

51. The management system of claim 27, wherein the at least one computing device is to
detect an event in response to determining, based upon the location observations for the plurality of healthcare resources, that a first healthcare resource used a second healthcare resource, and
request additional allocation of the second healthcare resource in response to initiating an action associated with the detected event.

52. The management system of claim 27, wherein the at least one computing device is to
detect an event in response to determining, based upon location observations for the plurality of healthcare resources, that a first healthcare resource of the plurality of healthcare resources has potentially contaminated a second healthcare resource of the plurality of healthcare resources, and
alert staff of the potential contamination in response to initiating an action associated with the detected event.

53. The management system of claim 27, wherein the at least one computing device is to
detect an event in response to determining, based upon location observations and status conditions for the plurality of healthcare resources, that a procedure was completed, and
verify protocol compliance in response to initiating an action associated with the detected event.

54. The management system of claim 27, wherein the at least one computing device is to match a first healthcare resource with a second healthcare resource of the plurality of healthcare resources in response to initiating an action associated with a detected event.

55. The management system of claim 27, wherein the at least one computing device is to
receive a voice command, and
detect that an event has occurred based upon the voice command.

56. The management system of claim 27, wherein the at least one computing device, in response to initiating an action associated with a detected event, is to
identify a communication device proximate a first healthcare resource of the plurality of healthcare resources associated with the detected event, and
annunciate the detected event via the communication device proximate the first healthcare resource of the plurality of resources.

57. The management system of claim 27, wherein the at least one computing device is to determine relational conditions between the plurality of healthcare resources based upon timestamps of the location observations for the plurality of healthcare resources.

58. The management system of claim 27, wherein the at least one computing device is to
update an acyclic graph based upon location observations and associated timestamps for the plurality of healthcare resources, and
determine relational conditions between the plurality of healthcare resources based upon the acyclic graph.

59. The management system of claim 57, wherein the at least one computing device is to
create, from the first plurality of location observations, a first plurality of edges to a first node of the acyclic graph that represents a first healthcare resource of the plurality of healthcare resources, and
create, from the second plurality of location observations, a second plurality of edges to a second node of the acyclic graph that represents a second healthcare resource of the plurality of healthcare resources.

60. The management system of claim 57, wherein the at least one computing device is to
associate timestamps to each edge of the first plurality of edges and the second plurality of edges to temporally identify location observations represented by the first plurality edges and the second plurality of edges.
